(19) United States
(12) Patent Application Publication
(10) Pub. No.: US 2005/0096952 A1
(43) Pub. Date: May 5, 2005

(54) Methods and systems for option-based product definition

(76) Inventors: Allan M. Hansen, Glencoe, MO (US); Scott A. Schieferdecker, O'Fallon, MO (US); Carl E. Bouffiou, Tacoma, WA (US); Bradley K. Jackson, Florissant, MO (US); David W. Patterson, Lynnwood, WA (US); Thomas S. Strevey, Marysville, WA (US); Lawrence W. Rogers, Kenmore, WA (US); Brian K. Thompson, Auburn, WA (US)

Correspondence Address: BLACK LOWE & GRAHAM, PLLC, 701 FIFTH AVENUE, SUITE 4800, SEATTLE, WA, 98104, US

(21) Appl. No.: 10/699,265

(22) Filed: Oct. 31, 2003

(51) Int. Cl. G06F 17/60

(52) U.S. Cl. 705/7

(57) ABSTRACT

Methods and systems for usage-based product definition are disclosed. In one embodiment, a method includes instancing one or more usage-based product definition inputs, and assessing at least one of an applicability expression, an engineering requirement, and a manufacturing availability expression. The method further includes generating the product definition based on at least some of the usage-based product definition inputs, applicability expressions, engineering requirements, and manufacturing availabilities. In alternate embodiments, the instancing may include transforming a coordinate system of a component from a component-centered coordinate system to a product-centered coordinate system.

### FIELD OF THE INVENTION

The present invention relates to methods and systems for option-based product definition, including, for example, methods and systems for definition of aerospace products.

### BACKGROUND OF THE INVENTION

As industry moves from paper drawing definition of products to computer model definition, the need to structure models within a complex variable product is required. For many years the product definition practice has been to define a product in the form of engineering assemblies, and defining an end-item product usage of the assembly on an external bill of material or on one of the drawing sheets. Manufacturing has been required to disassemble the engineering-defined product and reconstruct the assembly according to available manufacturing processes. This has resulted in multiple product structures and the resulting effort for reconciliation.

Although desirable results have been achieved using the prior art methods and systems, there is room for improvement. Specifically, the prior art methods and system have resulted in multiple product structures, which may require considerable effort to reconcile. Improved design methods and systems are therefore needed to rapidly and efficiently enable option-based changes in the product configuration process.

### SUMMARY OF THE INVENTION

The present invention is directed to methods and systems for option-based product definition. Apparatus and methods in accordance with the present invention may advantageously allow rapid and efficient option-based changes in the product configuration process, thereby reducing errors, improving consistency, and decreasing product configuration time and expense in comparison with prior art job requisition processes.

In one embodiment, a method for creating a product definition includes instancing one or more usage-based product definition inputs, and assessing at least one of an applicability expression, an engineering requirement, and a manufacturing availability expression associated with at least some of the usage-based product definition inputs. The method further includes generating the product definition based on at least some of the usage-based product definition inputs, applicability expressions, engineering requirements, and manufacturing availabilities. In alternate embodiments, the instancing of the one or more usage-based product definition inputs may include instancing a part or a requirement. In further embodiments, the instancing may include transforming a coordinate system of a component from a component-centered coordinate system to a product-centered coordinate system.

### BRIEF DESCRIPTION OF THE DRAWINGS

The preferred and alternative embodiments of the present invention are described in detail below with reference to the following drawings.

FIG. 1 is a schematic view of an option-based product definition process in accordance with an embodiment of the invention;

FIG. 2 is a flow chart of an option-based product definition process in accordance with an embodiment of the invention;

FIG. 3 is a schematic view of an option-based product definition process for an engine build-up in accordance with another embodiment of the invention;

FIG. 4 is a schematic view of an option-based product definition process for an aircraft in accordance with another embodiment of the invention;

FIG. 5 is a schematic view of multiple coordinate systems of a representative aircraft in accordance with an embodiment of the invention;

FIG. 6 is an implementation of an option-based product definition process for the aircraft of FIG. 5;

FIG. 7 shows a representative aircraft family in accordance with a further aspect of the invention;

FIG. 8 shows an option-based product definition process for the aircraft family of FIG. 7 in accordance with another embodiment of the invention;

FIG. 9 shows a representative result of applying a product configuration specification to the product definition process of FIG. 8;

FIG. 10 is a schematic view of an option-based product definition process having a plurality of configurations of a sub-product in accordance with another embodiment of the invention;

FIG. 11 is a schematic view of a product class configuration rule set in accordance with an alternate embodiment of the invention;

FIG. 12 is a schematic view of a configuration rule set of a pen product in accordance with another embodiment of the invention;

FIG. 13 is an option-based product definition process in accordance with a further embodiment of the invention;

FIG. 14 is a representative applicability in accordance with an embodiment of the invention;

FIG. 15 shows a pair of representative product configuration specifications in accordance with alternate embodiments of the invention;

FIG. 16 is an option-based product definition process for a representative tactical aircraft in accordance with a further embodiment of the invention;

FIG. 17 is an option-based product definition process implemented for a closet sub-component of a commercial aircraft in accordance with another embodiment of the invention;

FIG. 18 shows an option-based product definition process for a closet sub-component before a customer-specified change in accordance with a further embodiment of the invention;

FIG. 19 shows an option-based product definition process for a closet sub-component after a customer-specified change in accordance with a further embodiment of the invention; and

FIG. 20 shows an option-based product definition process for a closet sub-component after yet another customer-specified change in accordance with another embodiment of the invention.

### DETAILED DESCRIPTION OF THE INVENTION

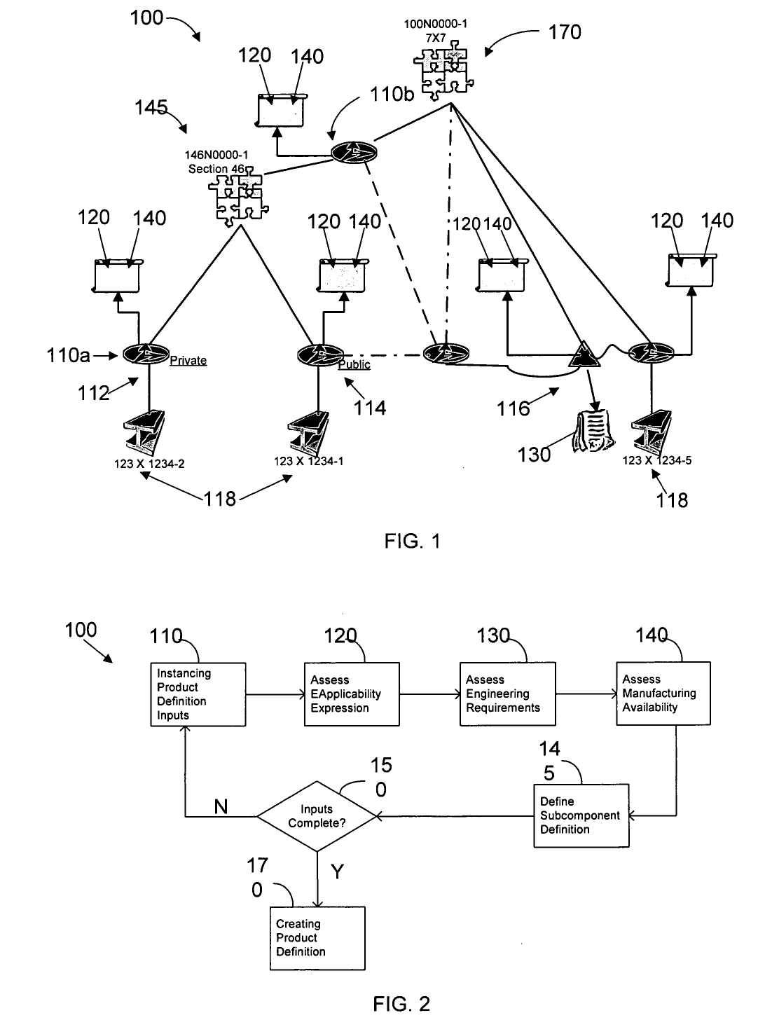

The present invention relates to methods and systems for option-based product definition. Many specific details of certain embodiments of the invention are set forth in the following description and in FIGS. 1-20 to provide a thorough understanding of such embodiments. One skilled in the art, however, will understand that the present invention may have additional embodiments, or that the present invention may be practiced without several of the details described in the following description.

Embodiments of methods and systems in accordance with the present invention may include characterizing a product configuration as a collection of parts, plans, requirements and other documentation that defines an individual product end item. More specifically, embodiments of methods and systems in accordance with the present invention may include defining a product configuration using applicability (e.g. options and availability). For example, a product configuration specification may be used to identify a collection of functions (options) to be met by the product. Availability may identify a sequential timing of the product functions available for delivery. Effectivity may be an evaluated configuration indicating an existence of individual elements of the product. As described more fully below, methods and systems in accordance with the present invention may provide a requirements-driven approach to product design wherein products and manufacturing processes are option-controlled.

More specifically, a product (e.g. air vehicle, consumer good, etc.), or a major component thereof, may represent a collection of configuration-controlled design and planning data from which the configuration of individual end items can be derived. The collection may define a context of the design environment in terms of control documents, coordinate systems, volumes, etc. All data within a product have an availability, which may be used as a filtering mechanism. Management, using customer, design, and manufacturing input, may decide what sub-products will be created and how they will be used in the product structure.

FIG. 1 is a schematic view of a usage-based product definition process 100 in accordance with an embodiment of the invention. FIG. 2 is a flow chart of the option-based product definition process 100 of FIG. 1. In this embodiment, the process 100 includes instancing usage-based product definition inputs 110. The usage-based product definition inputs may include one or more private instancings 112, one or more public instancings 114, and one or more engineering requirement callouts 116. The instancing of usage-based product definition inputs may draw upon one or more parts 118, and may depend from one or more applicability expressions 120, and from one or more engineering requirements 130. The process 100 assesses the one or more applicability expressions 120, engineering requirements 130, and manufacturing availabilities 140 to determine whether the product definition inputs 110 are available and valid. A product subcomponent definition 145 may then be generated. At a decision block 150 (FIG. 2), it is determined whether additional product definition inputs are needed. If so, then the process repeats with the instancing of additional product definition inputs 110, and additional assessing of applicability expressions 120, engineering requirements 130, and manufacturing availabilities 140. When all necessary product definition inputs have been received, then the product definition 170 is created, completing the process 100. The components of the process 100 shown in FIGS. 1 and 2 will be described in greater detail below.

Applicability is a statement defining the conditions under which an item is capable of being applied. The items to which applicability can be applied include part instances, engineering requirement callouts, product instances, manufacturing assembly plans, operations, and other suitable items. Applicability may be an expression composed of operands and Boolean operators. The operands may be option, serial range (e.g. start line number and end line number), date range (e.g. start date and end date), milestone (e.g. a named date), lot, and other suitable operands. Availability is an applicability expression without option operands. The Boolean operators may be NOT, AND, OR, and XOR. The NOT operator evaluates true when the option following the operator is not in the product configuration specification. The AND operator evaluates true when the option on both sides of the operator is included in the product configuration specification. The OR operator evaluates true when the option on either side or both sides of the operator is included in the product configuration. And the XOR operator evaluates true when only one option on either side of the operator is included in the configuration specification. Precedence rules for the Boolean operators are shown in the following table. Operators of equal precedence are evaluated left to right.

| | |
|---|---|
| First | NOT |
| | AND |
| | OR, XOR |

A typical Applicability applied to a part instance will include both option operands and serial range operands. For example, (2520B142) AND (327→∞) specifies that the part instance is applicable in products for Option 2520B142 delivered from line number 327 and on.

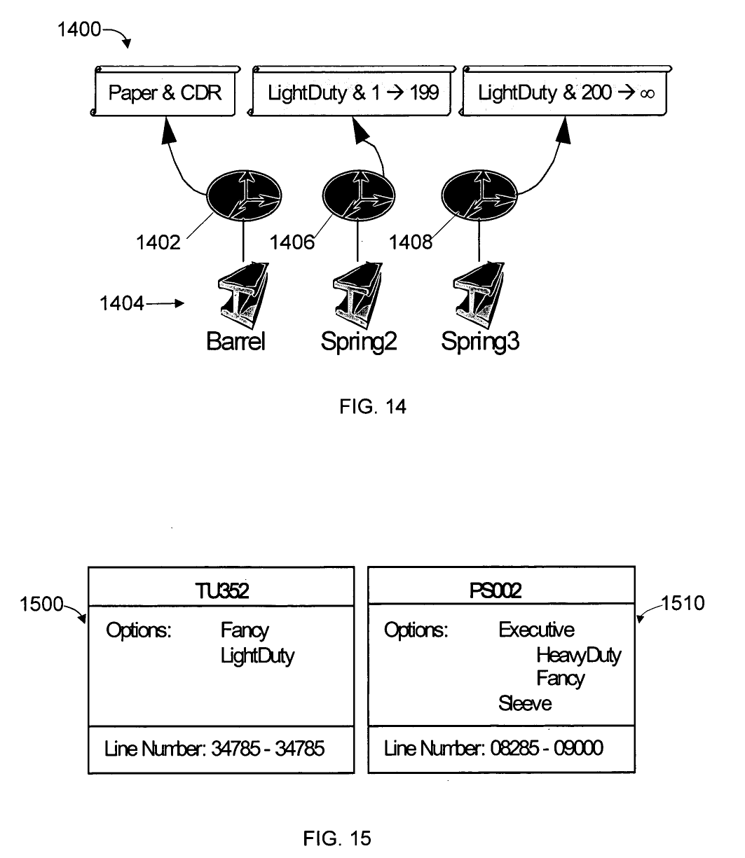

FIG. 14 is a representative applicability 1400 in accordance with an embodiment of the invention. In this embodiment, a part instance 1402 of a barrel 1404 is applicable on a product if a product configuration specification contains the option “Paper” and is for the Customer Design Review (CDR is a scheduled Milestone event). Similarly, a part instance 1406 of a Spring2 is applicable for the option “LightDuty” and for Line Number 1 through Line Number 199. A part instance 1408 of Spring3 is applicable for the “LightDuty” option from Line Number 200 and on. This could indicate that Spring2 is cutover to Spring3 on Line Number 200.

In yet another aspect, applicability may be defined in the context of a domain. Examples of an applicability domain include Engineering and Manufacturing. In one embodiment, the applicability in the Engineering Domain and the Manufacturing Domain will be identical by default for any particular item (a part instance or requirement callout, for example). There are business scenarios where the Manufacturing Domain applicability will extend the availability of a superceded part beyond what is defined in the Engineering Domain, but the superceded part is removed with an out of sequence process so that in the end, the Engineering definition is satisfied.

A product configuration specification defines a configuration of a product. The product configuration specification lists all options and the range(s) that define the specific units of the product. The product configuration specification may be maintained for the life of the product. Evaluation of the product using the product configuration specification may return all data related to the product for which the applicability expression is evaluated as TRUE. FIG. 15 show a pair of representative product configuration specifications 1500, 1510 in accordance with alternate embodiments of the invention.

Decisions on options to be offered and when those options will be available may be determined, for example, by customer requirements, product management team, and integrated product teams. A work statement may be developed that defines and authorizes execution of a work plan, including identification of each element to be performed, one or more options to be implemented, and a scheduled sequence for implementation.

In accordance with further embodiments of the invention, a manufacturing engineer may associate the product data to a process structure representing the manufacturing and assembly process. The activity of associating the product data to the process structure and managing that information for various configurations is the process planning and analysis activity. The process structure preferably accounts for every element of the product definition and may facilitate manufacturing analysis, e.g., assembly simulation, process flow analysis, etc. When the assembly process calls for producing discrete assemblies for subsequent installation on a production line, the manufacturing engineer creates assembly groupings organizing them in hierarchies, as required. These assembly groupings are referred to as manufacturing assembly plans and are exposed through the process structure. It is preferred that the manufacturing engineer creates and manages the majority of assemblies required to fabricate the product. This suggests that the product structure remain as “flat” as possible with the part and requirement instances associated directly to their product.

Process planning activities may be performed in the context of a 3D virtual product environment. This requires product data, from various levels of the product, to be available in the context of the plan being developed. The process structure supports definition and management of assembly sequence and sequence analysis data such as assembly simulations. A control station may group and organize the installation plans to be performed within factory locations for a product. Control stations are arranged in a precedence sequence by assigning the sequence availability. The availability of a control station is in the context of the product and is derived from control station predecessor relationships.

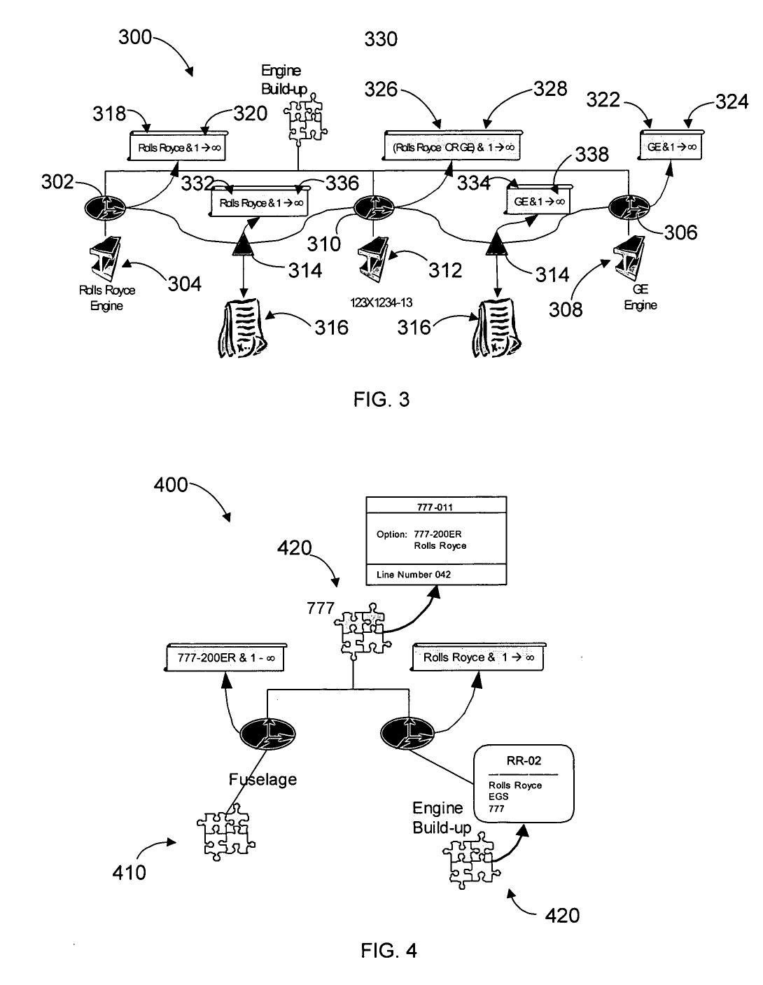

In some embodiments, both parts and requirements may be instanced onto products. The instantiation may contain the applicability to the product and its location on the product (if required). For example, FIG. 3 is a schematic view of an option-based product definition process 300 for an engine build-up in accordance with another embodiment of the invention. In this embodiment, the process 300 includes a first instance 302 calling for a first engine type 304 (e.g. a Rolls Royce engine), a second instance 306 calling for a second engine type 308 (e.g. a General Electric engine), and a third instance 310 calling for another part 312. One or more engineering requirement callouts 314 may result in corresponding engineering requirements 316. The process 300 may further include assessing a first applicability expression 318 and a first manufacturing availability expression 320 based on the first instantiation 302. Similarly, a second applicability expression 322 and a second manufacturing availability expression 324 may be assessing based on the second instantiation 306, and a third applicability expression 326 and a third manufacturing availability expression 328 may be generated based on the third instantiation 310. As further shown in FIG. 3, fourth and fifth applicability expressions 330, 332 and fourth and fifth manufacturing availability expressions 336, 338 may be generated based on the engineering callouts 314. Finally, a usage-based engine configuration definition 330 may be generated.

A product may be decomposed into sub-products to form a hierarchy. This structure of products may be defined by instancing a product, the instanced product being filterable by the product configuration specifications of the highest-level product. Alternately, a component configuration specification may be instanced (i.e. a uniquely configured item) wherein the product is filtered by its component configuration specifications dependent on the availability of the highest-level product.

For example, FIG. 4 is a schematic view of an option-based product definition process 400 for an aircraft in accordance with another embodiment of the invention. In this embodiment, a fuselage product 410 is instanced onto an aircraft 420 (e.g. a Model 777 aircraft commercially available from The Boeing Company of Chicago, Ill.). Similarly, an engine build-up component configuration specification 430 is instanced onto the aircraft 420. The options, within each of the products (aircraft 420 and engine build-up 430) may be independent of each product.

In some products, particularly relatively large products, it may be convenient to model different components of the product in their own coordinate system. For example,

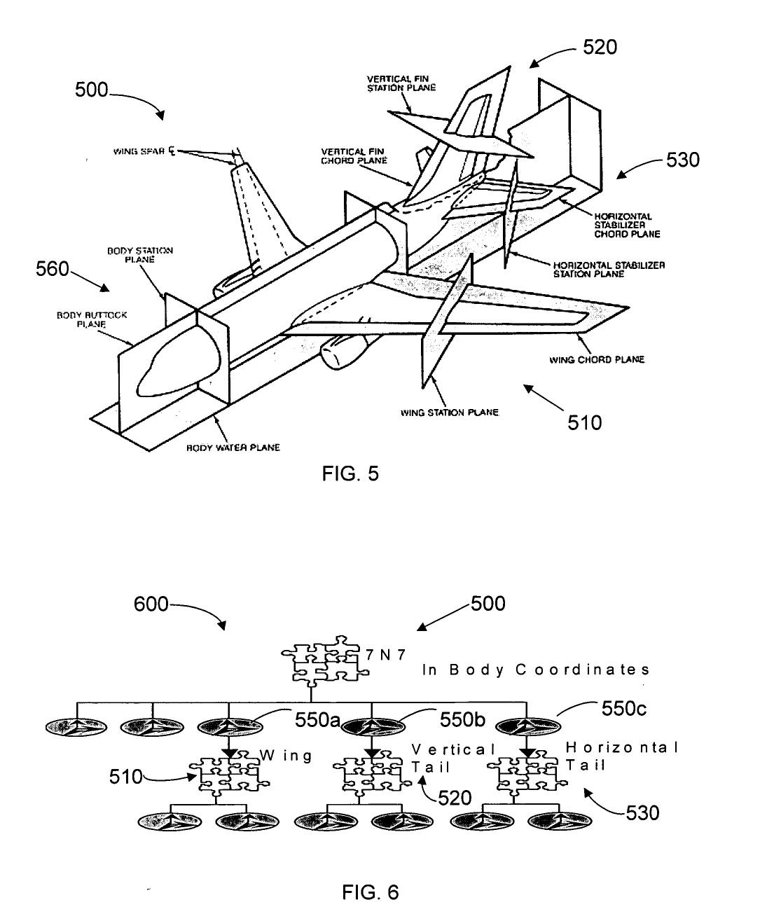

FIG. 5 is a schematic view of a plurality of coordinate systems of a representative aircraft 500 in accordance with an embodiment of the invention. As shown in FIG. 5, the aircraft 500 includes a wing 510, a vertical tail 520, and a horizontal tail 530, each having its own respective coordinate system. FIG. 6 is an implementation of an option-based product definition process 600 for the aircraft 500 of FIG. 5 that allows the wing 510, vertical tail 520, and horizontal tail 530 to be modeled in their own coordinate spaces. The instances 550 of the products manage the transformation of these coordinate systems to a body coordinate system 560 (FIG. 5).

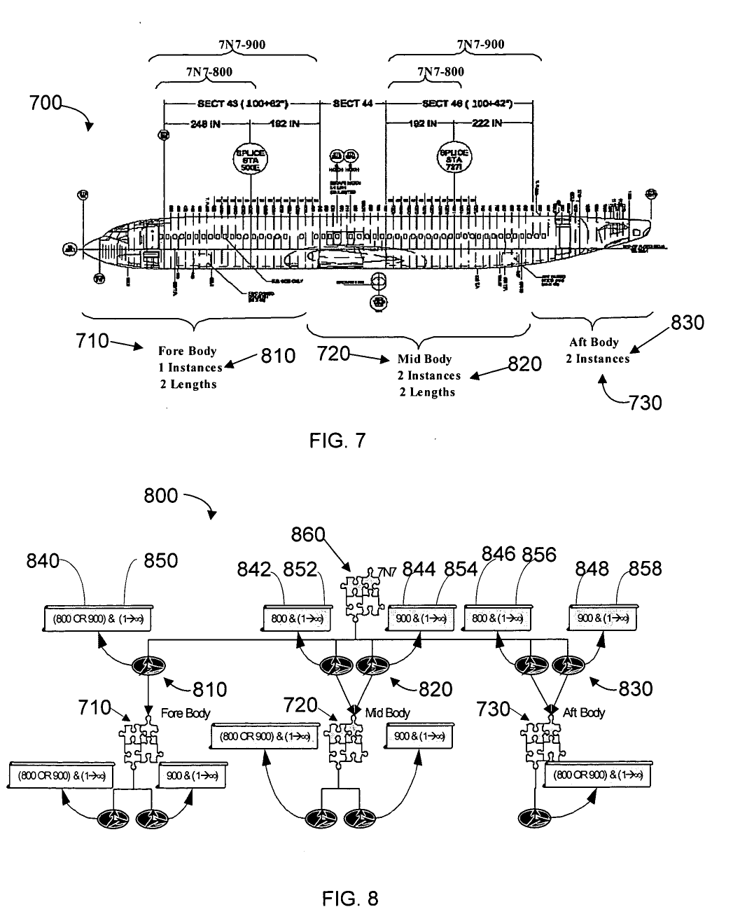

For some products, it may be desirable to develop a family of products having some degree of commonality. For example, it is common to develop a family of airplanes of different lengths. FIG. 7 shows a representative aircraft family 700 in accordance with a further aspect of the invention. In this embodiment, the aircraft family 700 includes a 7N7-800 model and a 7N7-900 model, with the 7N7-900 model adding length to a fore body 710 and a mid body 720 products. In this example, a Section 41 and a Section 43 are managed as the fore body 710, a Section 44 as the mid body 720, and everything aft of the Section 44 as an aft body 730 (wing, vertical tail, etc, are not shown, but would also be included). In this embodiment, the fore body 710 has two configurations (or lengths), one for the 7N7-800, and one for the 7N7-900 that would include all of the design instances added by the stretched derivative. As further shown in FIG. 7, the mid body 720 has two instances, one for the 7N7-800 derivative, and one for the 7N7-900 derivative that is translated back by a specified distance (e.g. 192 inches, the added length of the fore body 710). Similarly, the aft body 730 also has two instances, one for the 7N7-800, and one for the 7N7-900 that is translated back by a second specified distance (e.g. 414 inches, the added length of the fore body 710 plus the added length of the mid body 720).

FIG. 8 shows an option-based product definition process 800 for the aircraft family 700 of FIG. 7. As shown in FIG. 8, each of the fore body 710, mid body 720, and aft body 730 may be instanced onto the product definition process 800 by a fore body instance 810, a pair of mid body instances 820, and a pair of aft body instances 830. Each of these instances 810, 820, 830 invokes corresponding applicability expressions 840-848, and also corresponding manufacturing availability expressions 850-858, respectively. The instances 810, 820, 830 further combine to form a product definition 860.

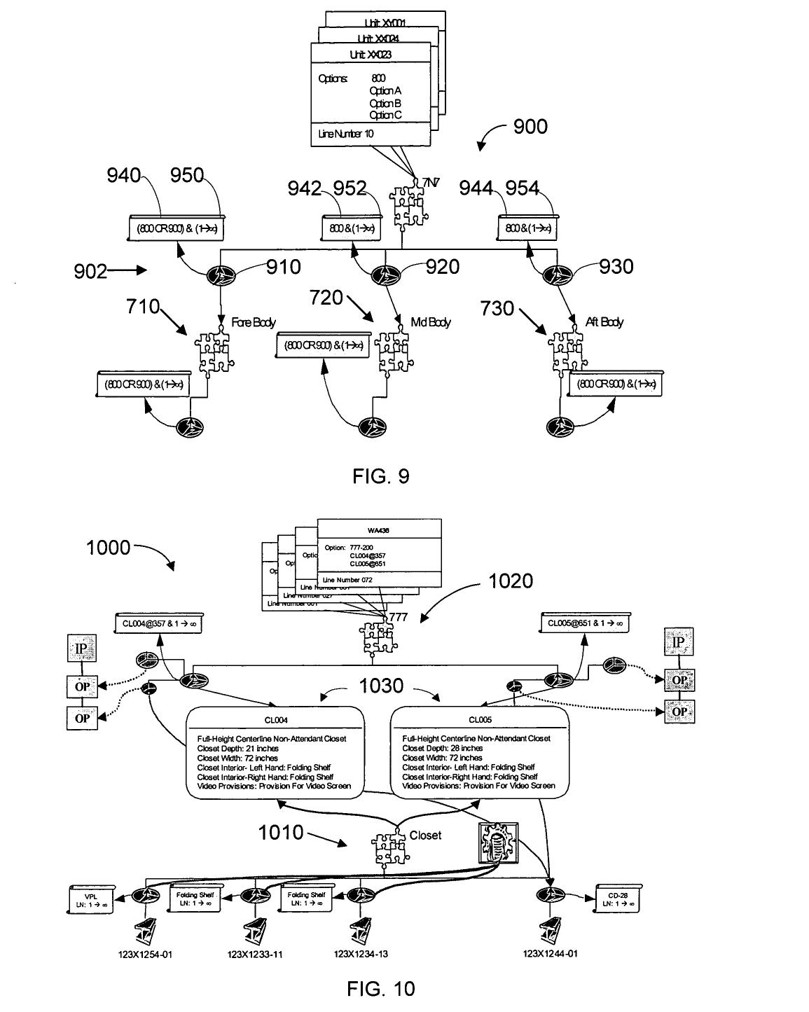

FIG. 9 shows a representative result 900 of applying a product configuration specification 902 to the product definition process 800 of FIG. 8. In this embodiment, the product configuration specification 902 is that of the 7N7-800 aircraft. The product configuration specification 902 includes an appropriate fore body instance 910, mid body instance 920, and aft body instance 930 that provides correspondingly appropriate fore body applicability and manufacturing availability expressions 940, 950, mid body applicability and manufacturing availability expressions 942, 952, and aft body applicability and manufacturing availability expressions 944, 954.

It may be appreciated that certain items may occur multiple times on a particular product, and may have different configurations at each location. For example, FIG. 10 is a schematic view of an option-based product definition process 1000 having a plurality of configurations of a sub-product 1010 in accordance with another embodiment of the invention. In this embodiment, the sub-products 1010 are closets. As shown in FIG. 10, there may be multiple closets 1010 on an aircraft 1020 and multiple closet configurations 1030 (widths, shelves, rods, etc.). To insure that the correct closet configuration 1030 is used at a particular location, it is necessary to instance specific configurations of the closet 1010 in the higher-level product 1020. Other sub-products that may also be instanced multiple times on the aircraft 1020 include but are not limited to lavatories, galleys, class dividers, and many other sub-products.

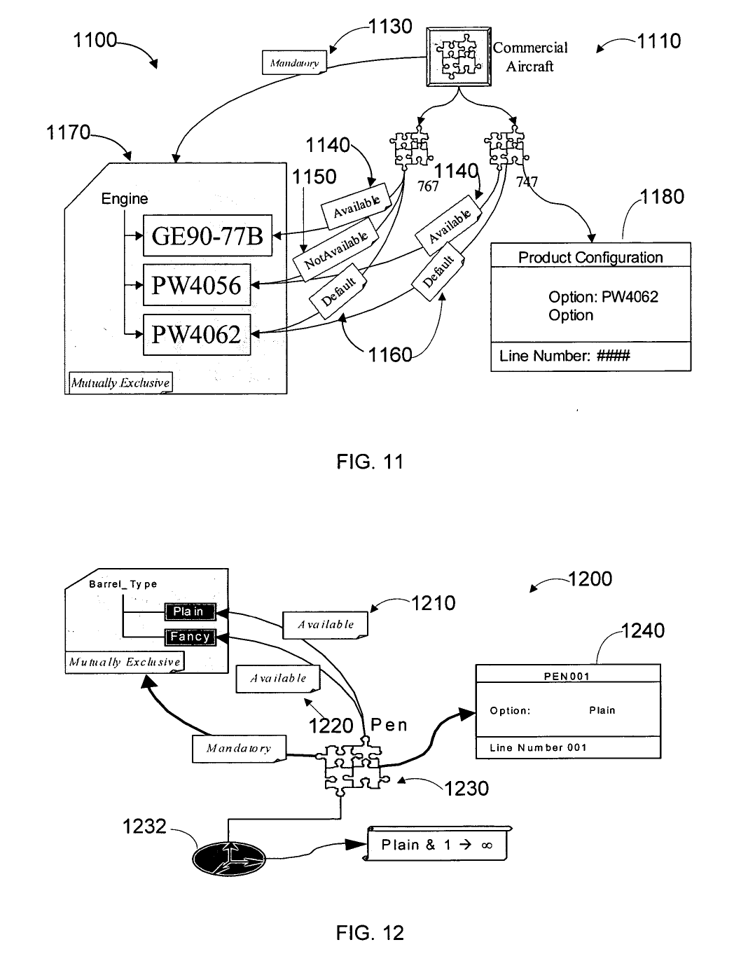

It may also be appreciated that a product class (or grouping of products) may be defined and may provide a mechanism to apply certain configuration rules that apply to an entire set of products. For example, FIG. 11 is a schematic view of a product class configuration rule set 1100 in accordance with an alternate embodiment of the invention. In this embodiment, a product class 1110 (e.g. “Commercial Aircraft”) may contain an entire set of airplane products (e.g. Model Nos. 737, 747, 757, 767, 777, etc. commercially available from The Boeing Company). The product class configuration rule set 1110 may include one or more mandatory configuration rules 1130, available configuration options 1140, configuration prohibitions 1150, and configuration defaults 1160 for any desired sub-product 1170. A product configuration 1180 may be defined that contains a plurality of instances that make up a desired product design.

In another aspect, an option is a statement of functionality or service that may be selected to define a specific configuration of a product. Options may be used in applicability statements to control when part instances, product instances, manufacturing assembly plans, etc. are valid for a particular unit of a product. Thus, options may also be used in configuration specifications to define the configuration of the product. For example, FIG. 12 is a schematic view of a configuration rule set 1200 of a pen product 1230 that has both a plain option 1210 and a fancy option 1220. An instance 1232 is applicable on the pen 1230 for the plain option 1210 and a product configuration specification 1240 will evaluate the pen product 1230 for the plain option 1210.

Options may be associated to products to specify that the option is valid for that product. For example, for each product, option may be defined as “default”, “available”, “not available”, or other suitable designations. A “default” option may also be defined for a valid configuration of a product (i.e., it is automatically specified), and may be replaced by an “available” option in a valid configuration of the product. For example, a single panel door may be a default door option on a particular aircraft lavatory, however, a customer may replace this default with an available bi-fold door option. An option that is defined as “not available” for a specific product cannot be specified in a valid configuration specification of that product.

Furthermore, an option category is a classification of options into groups that provide similar functionality. An option category may be associated to products or product classes. Examples of option categories may include, for example, engines, voice communications, weapon systems, or any other desired sub-components or product characteristics. Option categories may implement rules that may be defined mandatory or mutually exclusive. A mandatory option category includes one or more options that must be specified in a configuration specification and is defined on the relationship between the option category and the product or product class. A mutually exclusive option category provides that one or none of the options within the category must be specified in the configuration specification.

For example, as shown in FIG. 11, an option category for engines 1130 associated to the product class of “Commercial Aircraft” 1110 is a mandatory option class. This defines that an engine in the engine option category 1130 must be specified for any airplane contained in the Commercial Aircraft product class 1110. The option category engine 1130 would contain all of the options for the different engines used on commercial aircraft. As further shown in FIG. 11, the PW4056 option is available for a 747 product, but is not available for a 767 Product. Furthermore, FIG. 11 shows that the various engine options within the option category are mutually exclusive, that is, all of the engines on the aircraft must be of one specified option type.

In some embodiments, configuration rules may be defined in addition to the rules enforced with option categories. Such configuration rules can have two different behaviors: one is to validate the configuration specification, and the other is to populate the configuration specification. The behavior of a particular configuration rule may be set when the rule is created. These configuration rules may define option sets (or packages), contingencies between options, and exclusions between options.

Option sets may be defined as a group of options with a rule of the form: “If Option A, then Option B, Option C, Option D”, etc. Thus, if Option A is included in a product configuration specification, then Option B, Option C, and Option D are also necessarily included. Contingent options may also be defined. Contingent options are options that are valid only if another specified option is also included in the configuration. Contingent options may be defined with a rule of the form: “If Option B, then only if Option A”, where Option B is contingent on Option A. Further, exclusion options may be defined which are not compatible with options in other option categories (as opposed to mutually exclusive options which applies only to options within the same option category). For example, certain options that are valid on passenger airplanes may not be valid on freighter airplanes, defined as “If Option A, then NOT Option B” (e.g. “If Passenger Then NOT Heavy Duty Cargo Handling”).

Multiple instances of common reference parts can present issues as the reference part is addressed in different ways. This is addressed with the concept of a public instance and instance representation. When referring to data in a lower-level product from a higher-level product, the data must be available in the context of that higher-level product. To accomplish this, the data in the lower-level product are identified as public. The default for data is private. The lower level data are visible in most user interface depictions of the structure but cannot be referenced by other data without being made public.

An instance is made public by a discipline. For example, an instance from a lower level product may be consumed by manufacturing engineering at a higher-level product. That instance needs to be public so that the public instance representation can be addressable at the higher-level. A public instance representation refers to the public instance within the lower level product. The public instance representation maybe filtered through the instance of the higher-level product. The applicability of the public instance representation is the same as the public instance.

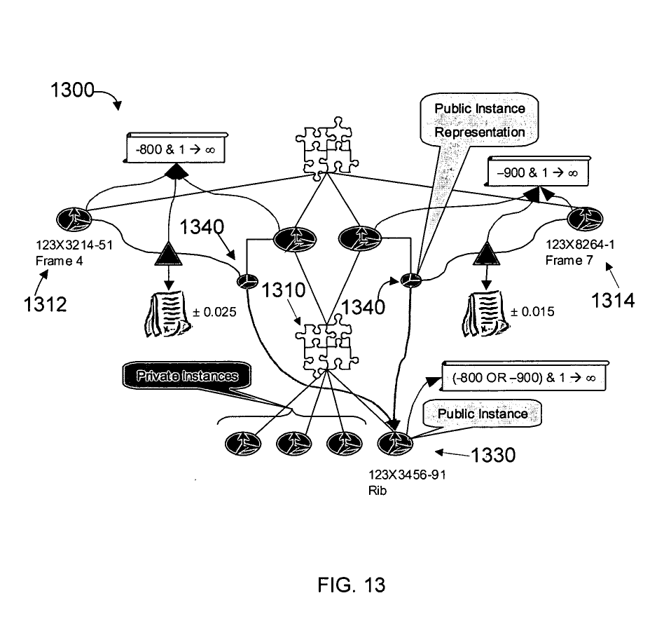

For example, FIG. 13 is an option-based product definition process 1300 in accordance with a further embodiment of the invention. In this embodiment, a lower-lever part 1310, in this case a rib, must be located within a tolerance of two different upper-level parts (e.g. frames) 1312, 1314. Since the lower-level part 1310 is used in multiple locations, the unique usage of the rib 1310 in each of the part usages 1312, 1314 must be referenced versus the rib itself 1310. Thus, a public instance data 1330 is available and addressable at a higher-level by one or more public instance representations 1340.

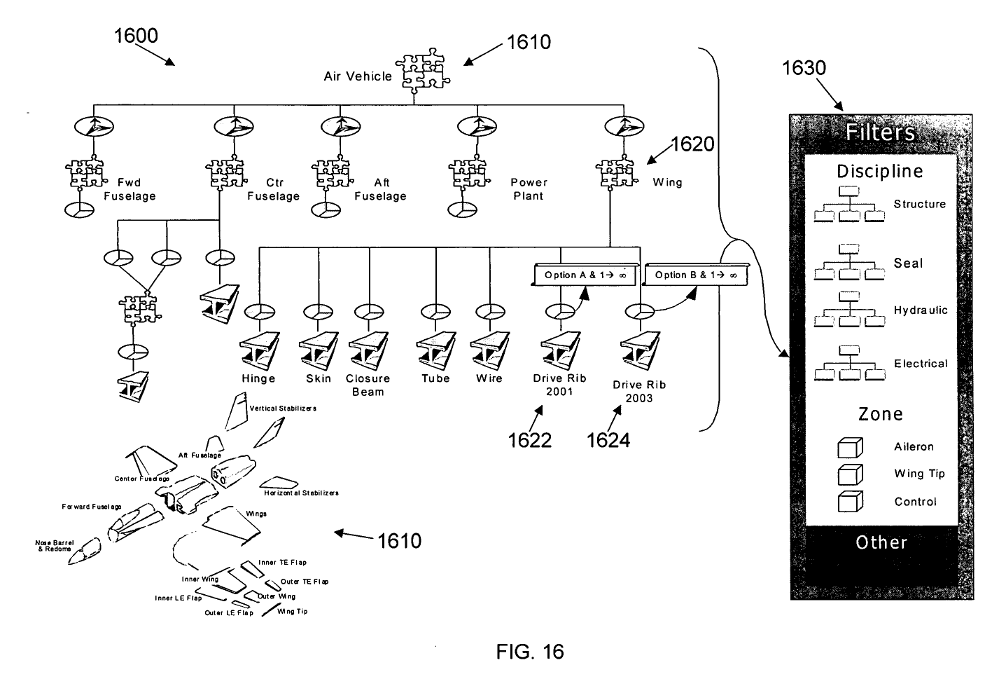

It will be appreciated that embodiments of methods and systems in accordance with the present invention may be conceived and applied to virtually any product. In one embodiment, for example as shown in FIG. 16, an option-based product definition process 1600 may be conceived for a representative tactical air vehicle 1610 in accordance with a further embodiment of the invention. In this embodiment, the air vehicle 1610 is partitioned into multiple sub-components (e.g. nose barrel and radome, forward fuselage, center fuselage, aft fuselage, wings, horizontal stabilizers, and vertical stabilizers). For the wing sub-component 1620, the process 1600 provides for two options of drive rib, namely, a first drive rib 1622 and a second drive rib 1624. A filter set 1630 is applied to the instancing of the process 1600 to provide one or more applicability and availability rules to ensure valid product definition of the air vehicle 1610. In the context of a 3D virtual product system, the filter set 1630 may enable a product designer to filter the product structure to get different views of a particular air vehicle configuration, or to view different air vehicle configurations.

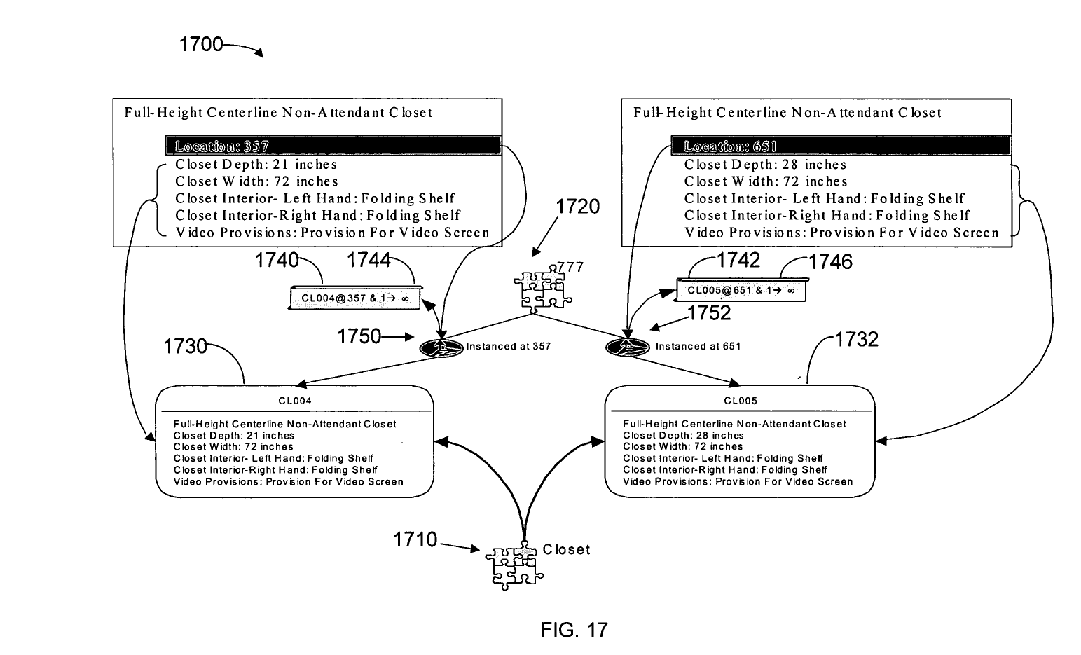

FIG. 17 is an option-based product definition process 1700 implemented for a closet sub-component 1710 of a commercial aircraft 1720 in accordance with another embodiment of the invention. In this embodiment, a customer (not shown) may select (or instance) a first closet 1730 (e.g. a Full-Height Centerline Non-Attendant Closet at location 357) and a second closet 1732 (e.g. a Full-Height Centerline Non-Attendant Closet at location 651). The closets 1730, 1732 are approximately the same dimensions except for depth (21 inches deep and 28 inches deep, respectively). As specified in their respective first and second applicability expressions 1740, 1742 and manufacturing availability expressions 1744, 1746, both closets 1730, 1732 are available for Line Numbers 1 and on, (i.e., the configurations are reusable). Engineering may invoke a first instance 1750 to install the first closet 1730, and a second instance 1752 to install the second closet 1732, at the customer-specified locations and applies the unique applicability.

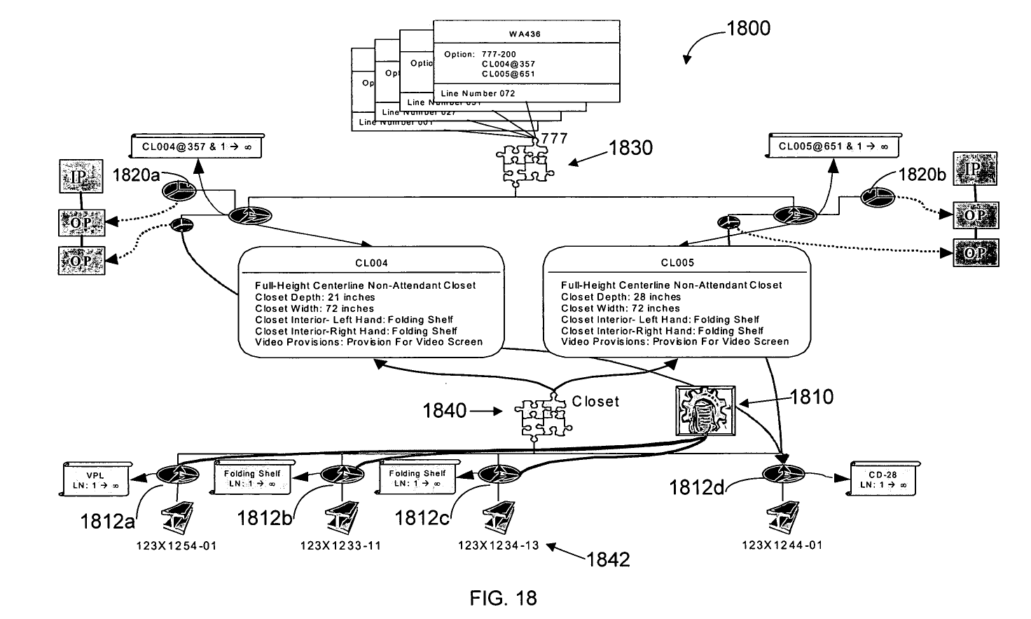

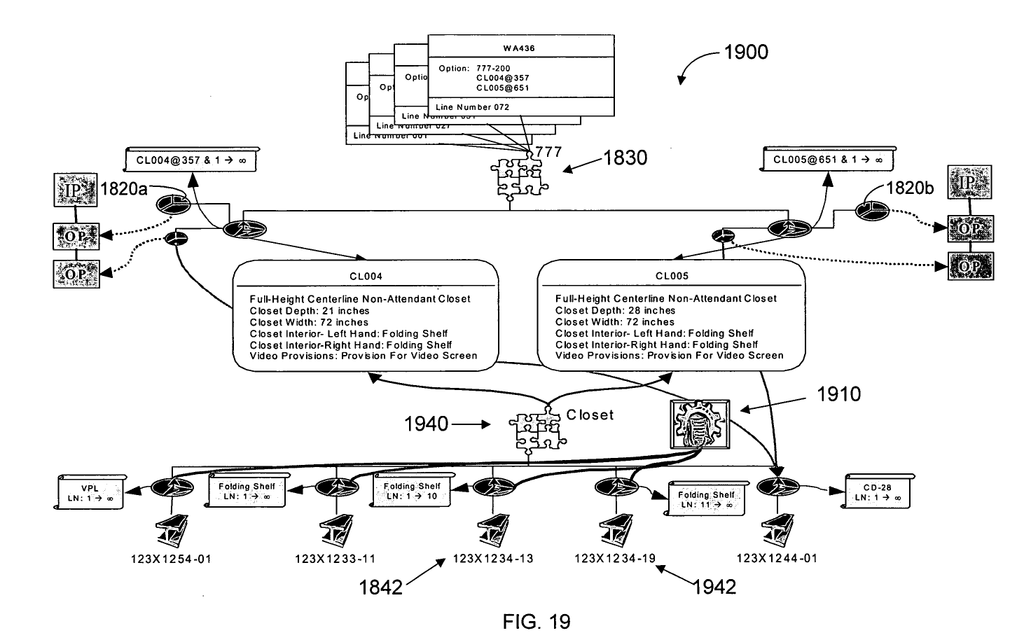

A “configuration at location” option may be added to the customer's product configuration specifications. For example, FIGS. 18 and 19 show option-based product definition processes 1800, 1900 for closet sub-components before and after a customer-specified change, respectively, in accordance with further embodiments of the invention.

As shown in FIG. 18, a unitized manufacturing assembly plan 1810 may be created. In general, the unitized manufacturing assembly plan 1810 may be used to assemble components that support a common product with variable configurations. The configuration of this type of plan is determined by the applicability of its components. When the assembly has been completed, a tag may be affixed to the assembly denoting the unitized manufacturing assembly plan number and line number for which the assembly was built. The assembly may then be stored in a parts control area for later use in an installation plan.

The make up of the unitized manufacturing assembly plan 1810 may be changed at any time to facilitate process changes. These changes may not require the product structure to change and may allow flexibility to change assembly configurations to support process changes. The part number identifier for the assembly may not be required to change when the assembly configuration is revised. The configuration of the unitized manufacturing assembly can be the same as, more than, or less than the associated product.

The applicability of the unitized manufacturing assembly plan 1810 will be managed by availability. When a component is included in the unitized manufacturing assembly plan 1810 the applicability will be added to and managed on the relationship between the part instance, assembly instance, or requirement callout and the operation in the unitized manufacturing assembly plan 1810.

When a component of the unitized manufacturing assembly plan 1810 is effective for a configuration not accounted for in an assembly plan, the component will be used directly on an installation plan for the line numbers not accounted for by the assembly plan. This is accomplished by specifying the availability that is not covered by the assembly plan on the manufacturing domain of the part instance. The part instance may then be declared as a “public” instance for the line numbers identified and exposed as a manufacturing instance representation for the installation plan, and provides for accountability of the part instance when it is associated to an operation. The unitized manufacturing assembly plan 1810 may be used in a shop which is the factory area where the plan is executed resulting in a physical assembly. The relationship between the unitized manufacturing assembly plan 1810 and the shop contains availability. If the plan is moved from one shop to another, it is accomplished by limiting the availability to one shop and adding availability to the other.

As further shown in FIG. 18, the part instances 1812A-1812D are designated as public. The public instance representations 1812 and manufacturing assembly representations 1820A and 1820B are consumed at the air vehicle definition 1830.

Under the “configuration at location” option, when the customer changed a closet product 1840, for example, from a first sub-part 1842 (e.g. a “−13”, FIG. 18) to a second sub-part 1942 (e.g. a “−19”, FIG. 19) at line 11. It will be appreciated that the customer-specified change impacts the process 1800 at the closet product level 1840 and not at the air vehicle definition level 1830.

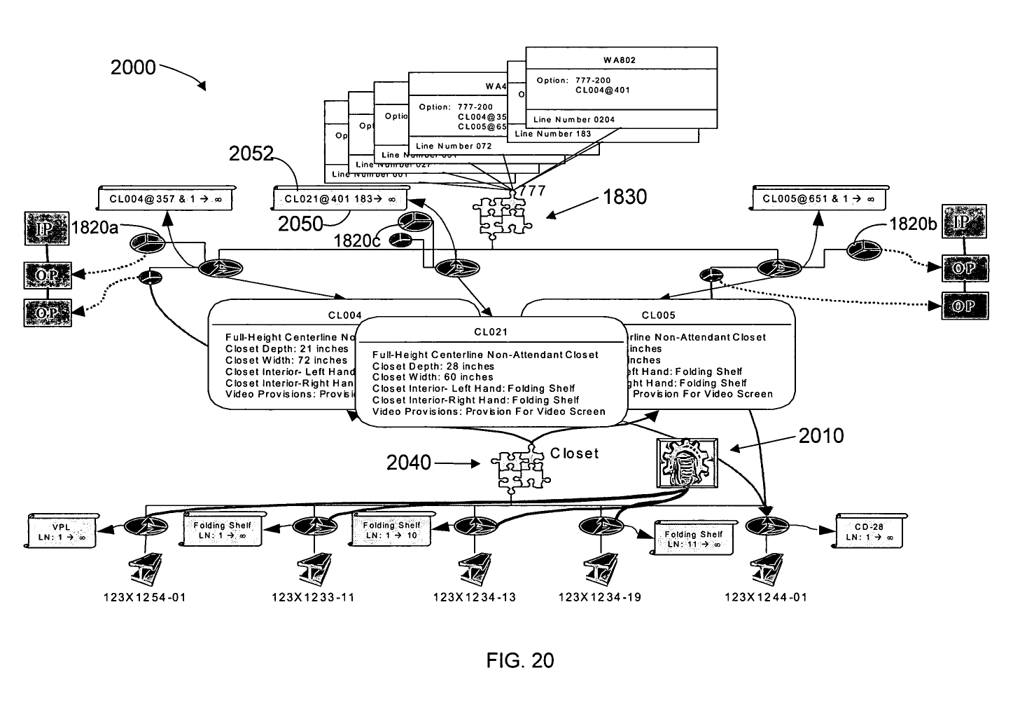

FIG. 20 shows an option-based product definition process 2000 for the closet sub-component of FIGS. 18 and 19 after yet another customer-specified change. In this embodiment, another customer invokes a third instance 1820C to select a third closet sub-part 2040 (e.g. 60-inch width closet at 401). As shown in the corresponding manufacturing availability expression 2050, the third instance 1820C is available at Line Number 183 (this customer's first airplane 1830) and on. Also, as shown in the corresponding manufacturing applicability expression 2052, the third instance 1820C of the third closet 2040 (e.g. the CLO21 configuration) is created at 401.

While one or more exemplary embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for creating a product definition, comprising:
instancing one or more usage-based product definition inputs;
assessing at least one of an applicability expression, an engineering requirement, and a manufacturing availability expression associated with at least some of the usage-based product definition inputs; and
generating the product definition based on at least some of the usage-based product definition inputs, applicability expressions, engineering requirements, and manufacturing availabilities.

2. The method of claim 1, wherein instancing one or more usage-based product definition inputs includes instancing a part.

3. The method of claim 1, wherein instancing one or more usage-based product definition inputs includes instancing a requirement.

4. The method of claim 1, wherein instancing one or more usage-based product definition inputs includes transforming a coordinate system of a part from a part-centered coordinate system to a product-centered coordinate system.

5. The method of claim 1, wherein instancing one or more usage-based product definition inputs includes instancing a sub-component having a first configuration, and instancing the sub-component a second time having a second configuration.

6. The method of claim 1, wherein instancing one or more usage-based product definition inputs includes instancing a predetermined component based on a product class configuration rule.

7. The method of claim 6, wherein the instancing a predetermined component based on a product class configuration rule includes instancing a predetermined component based on a mandatory configuration rule.

8. The method of claim 6, wherein the instancing a predetermined component based on a product class configuration rule includes instancing a predetermined component based on a configuration default rule.

9. The method of claim 1, wherein assessing at least one of an applicability expression, an engineering requirement, and a manufacturing availability expression includes assessing an option expression.

10. The method of claim 9, wherein assessing an option expression includes assessing at least one of a default option expression, an available option expression, and a not available option expression.

11. The method of claim 9, wherein assessing an option expression includes assessing an option from an option category associated to a product.

12. The method of claim 9, wherein assessing an option expression includes assessing at least one of a mandatory option or a mutually exclusive option.

13. The method of claim 1, wherein assessing at least one of an applicability expression, an engineering requirement, and a manufacturing availability expression includes assessing a configuration rule, the configuration rule being adapted to at least one of validate a configuration specification and populate a configuration specification.

14. The method of claim 1, wherein instancing one or more usage-based product definition inputs includes instancing a public instance representation of a lower level product by a higher level product.

15. The method of claim 14, wherein instancing a public instance representation of a lower level product by a higher level product includes filtering the public instance representation through the instance of the higher-level product.

16. The method of claim 1, wherein instancing one or more usage-based product definition inputs includes instancing in accordance with a configuration at location option by a customer.

17. The method of claim 1, wherein at least one of instancing one or more usage-based product definition inputs includes instancing in accordance with a unitized manufacturing assembly plan.

18. The method of claim 1, wherein assessing at least one of an applicability expression, an engineering requirement, and a manufacturing availability expression includes assessing in accordance with a unitized manufacturing assembly plan.

19. The method of claim 1, further comprising defining a sub-component configuration definition.

20. The method of claim 1, wherein assessing at least one of an applicability expression, an engineering requirement, and a manufacturing availability expression includes assessing an applicability expression, assessing an engineering requirement, and assessing a manufacturing availability expression.

21. A method for creating an air vehicle definition, comprising:
instancing a usage-based fuselage definition input, the usage-based fuselage definition input including at least one of a fore body definition input, a mid body definition input, an aft body definition input, a wing definition input, a vertical tail definition input, and a horizontal tail definition input;
instancing a usage-based propulsion system definition input;
assessing at least one of an applicability expression, an engineering requirement, and a manufacturing availability expression associated with at least some of the definition inputs; and
generating the air vehicle definition based on at least some of the definition inputs, applicability expressions, engineering requirements, and manufacturing availabilities.

22. The method of claim 21, wherein instancing at least some of the definition inputs includes transforming a coordinate system of a component from a component-centered coordinate system to an air vehicle-centered coordinate system.

23. The method of claim 21, wherein instancing at least some of the definition inputs includes instancing a predetermined component based on a product class configuration rule.

24. The method of claim 23, wherein the instancing a predetermined component based on a product class configuration rule includes instancing a predetermined component based on a mandatory configuration rule.

25. The method of claim 23, wherein the instancing a predetermined component based on a product class configuration rule includes instancing a predetermined component based on a configuration default rule.

26. The method of claim 21, wherein assessing at least one of an applicability expression, an engineering requirement, and a manufacturing availability expression includes assessing at least one of a default option expression, an available option expression, and a not available option expression.

27. The method of claim 21, wherein assessing at least one of an applicability expression, an engineering requirement, and a manufacturing availability expression includes assessing a configuration rule, the configuration rule being adapted to at least one of validate a configuration specification and populate a configuration specification.

28. The method of claim 21, wherein instancing at least one of the definition inputs includes instancing a public instance representation of a lower level product by a higher level product.

29. The method of claim 28, wherein instancing a public instance representation of a lower level product by a higher level product includes filtering the public instance representation through the instance of the higher-level product.

30. The method of claim 21, wherein at least one of instancing the definition inputs and assessing at least one of an applicability expression, an engineering requirement, and a manufacturing availability expression includes at least one of instancing and assessing in accordance with a unitized manufacturing assembly plan.
